(19) United States
(12) Patent Application Publication
(10) Pub. No.: US 2024/0267811 A1
(43) Pub. Date: Aug. 8, 2024

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Mitsutaka HATA, Yokohama-shi (JP)

(73) Assignee: KYOCERA Corporation, Kyoto (JP)

(21) Appl. No.: 18/640,691

(22) Filed: Apr. 19, 2024

Related U.S. Application Data
(63) Continuation of application No. PCT/JP2022/038737, filed on Oct. 18, 2022.

(30) Foreign Application Priority Data
Oct. 20, 2021 (JP) 2021-171706

(51) Int. Cl. H04W 36/08; H04W 36/00

(52) U.S. Cl. CPC H04W 36/08; H04W 36/0061; H04W 36/0072

(57) ABSTRACT

In a first aspect, a communication control method is a communication control method in a user equipment. The communication control method includes: transmitting, to a core network apparatus, information indicating a plurality of network slices desired by a user equipment; and receiving, from the core network apparatus, information indicating a priority of each of the plurality of network slices.

### RELATED APPLICATIONS

The present application is a continuation based on PCT Application No. PCT/JP2022/038737, filed on Oct. 18, 2022, which claims the benefit of Japanese Patent Application No. 2021-171706 filed on Oct. 20, 2021. The content of which is incorporated by reference herein in their entirety.

### TECHNICAL FIELD

The present invention relates to a communication control method and a user equipment in a mobile communication system.

### BACKGROUND OF INVENTION

In specifications of the Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP TS 38.300 V16.6.0 (2021 June)

### SUMMARY

### Solution to Problem

In a first aspect, a communication control method is a communication control method in a user equipment. The communication control method includes: transmitting, to a core network apparatus, information indicating a plurality of network slices desired by a user equipment; and receiving, from the core network apparatus, information indicating a priority of each of the plurality of network slices.

In a second aspect, a user equipment includes a processor. The processor performs: processing of transmitting, to a core network apparatus, information indicating a plurality of network slices desired by a user equipment; and processing of receiving, from the core network apparatus, information indicating a priority of each of the plurality of network slices.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to an embodiment.

FIG. 3 is a diagram illustrating a configuration example of a gNB (a base station) according to an embodiment.

FIG. 4 is a diagram illustrating a configuration example of a protocol stack for a user plane according to an embodiment.

FIG. 5 is a diagram illustrating a configuration example of a protocol stack for a control plane according to an embodiment.

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram for illustrating an example of slice frequency information.

FIG. 11 is a flowchart illustrating a basic flow of the slice-specific cell reselection procedure.

FIG. 12 is a diagram illustrating an operation example according to a first embodiment.

FIG. 13 is a diagram illustrating an operation example according to a second embodiment.

### DESCRIPTION OF EMBODIMENTS

A user equipment in a radio resource control (RRC) idle state or an RRC inactive state performs a cell reselection procedure. In the 3GPP, slice-specific cell reselection that is a network slice-dependent cell reselection procedure is under study.

In such slice-specific cell reselection, for example, it is assumed that the user equipment preferentially reselects (that is, camps on) a cell belonging to a frequency having a high frequency priority associated with a network slice that the user equipment wants to use (intended slice). However, a specific method of the slice-specific cell reselection is not yet determined.

The present disclosure aims at cell reselection being appropriately performed.

A mobile communication system according to an embodiment is described with reference to the drawings. In the description of the drawings, the same or similar parts are denoted by the same or similar reference signs.

### First Embodiment

### Configuration of Mobile Communication System

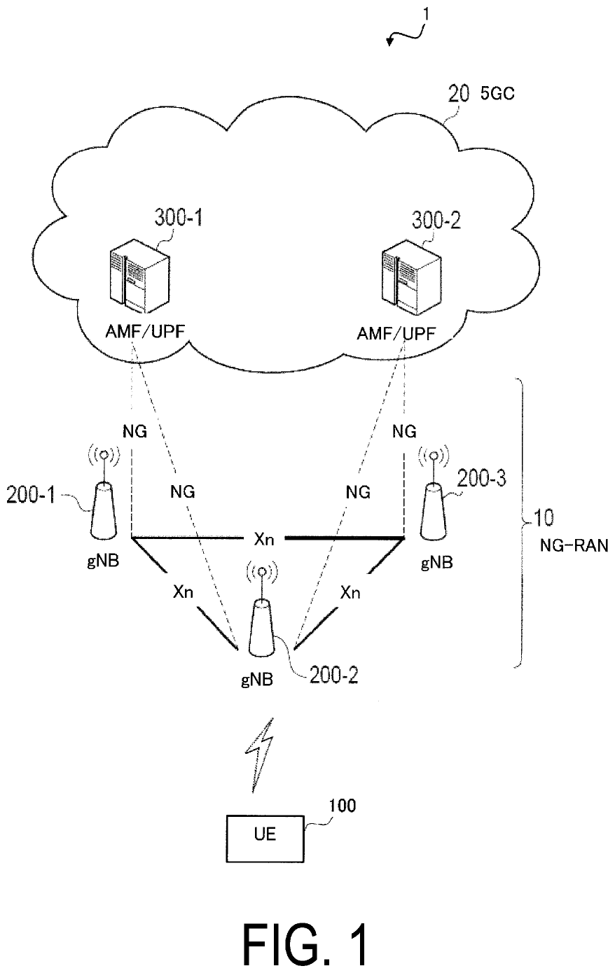

FIG. 1 is a diagram illustrating a configuration of a mobile communication system according to a first embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication to the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency” below).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

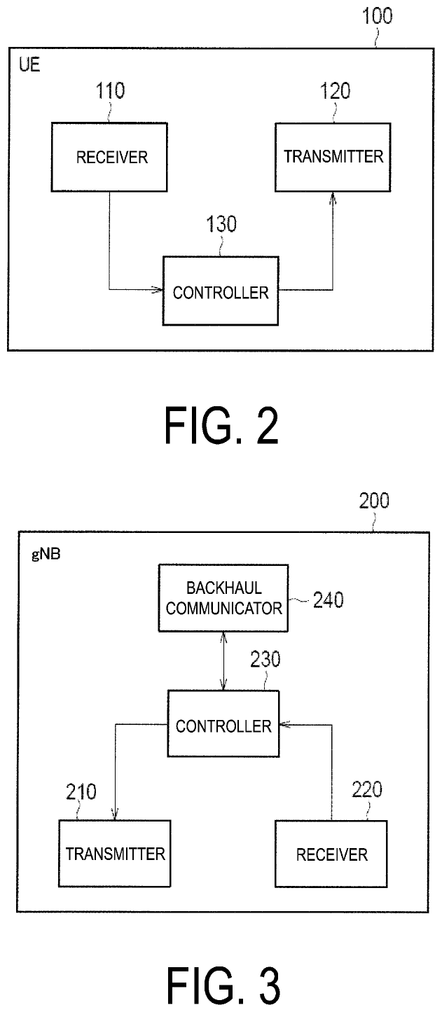

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the Xn interface, which is an inter-base station interface. The backhaul communicator 240 is connected to the AMF/UPF 300 via the NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

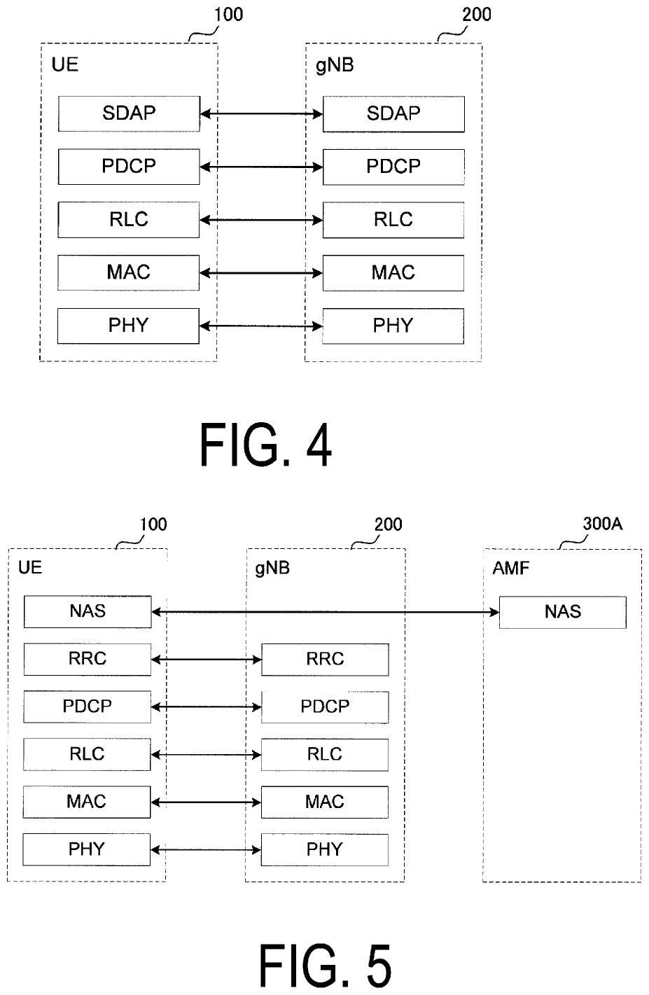

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled using the RNTI.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines uplink and downlink transport formats (transport block sizes, modulation and coding schemes (MCSs)), and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of Cell Reselection Procedure

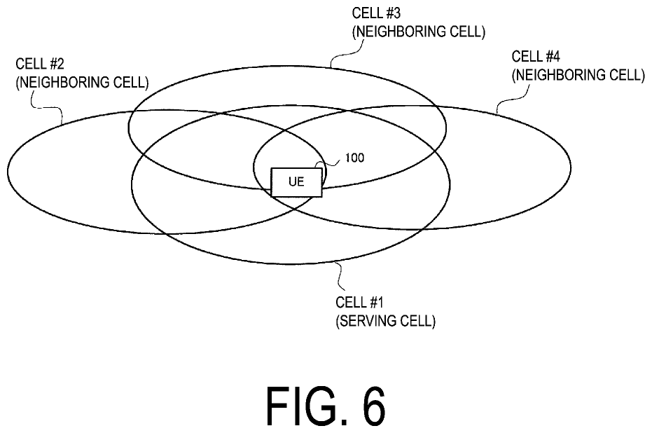

FIG. 6 is a diagram for illustrating an overview of the cell reselection procedure.

The UE 100 in the RRC idle state or the RRC inactive state while moving performs the cell reselection procedure to move from a current serving cell (a cell #1) to a neighboring cell (any one of cells #2 to #4). To be more specific, the UE 100 specifies a neighboring cell on which the UE 100 should camp through the cell reselection procedure and reselects the specified neighboring cell. When the frequency (carrier frequency) is the same between the current serving cell and the neighboring cell is referred to as an intra-frequency, and when the frequency (carrier frequency) is different between the current serving cell and the neighboring cell is referred to as an inter-frequency. The current serving cell and the neighboring cell may be managed by the same gNB 200 or may be managed by the gNBs 200 different from each other.

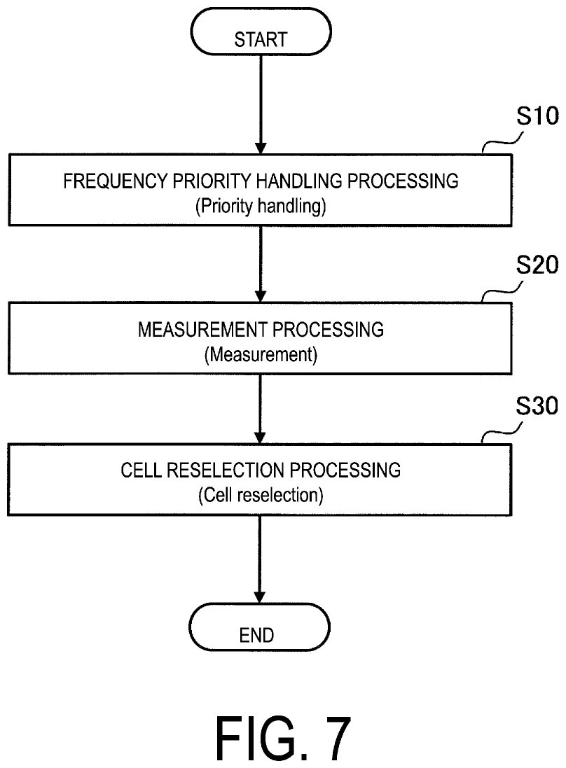

FIG. 7 is a flowchart illustrating a schematic flow of a typical cell reselection procedure.

In step S10, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 continuously measures the radio quality for a frequency with a priority higher than the priority of the frequency of the current serving cell, and when the radio quality of the current serving cell is lower than a predetermined quality, the UE 100 measures the radio quality for a frequency with a priority equal to or lower than the priority of the frequency of the current serving cell.

In step S30, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the priority of the frequency of the neighboring cell is lower than the priority of the current serving cell, and when the radio quality of the current serving cell is lower than a certain threshold value and the radio quality of the neighboring cell is continuously higher than another threshold value for a predetermined period of time, the UE 100 may perform cell reselection to the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

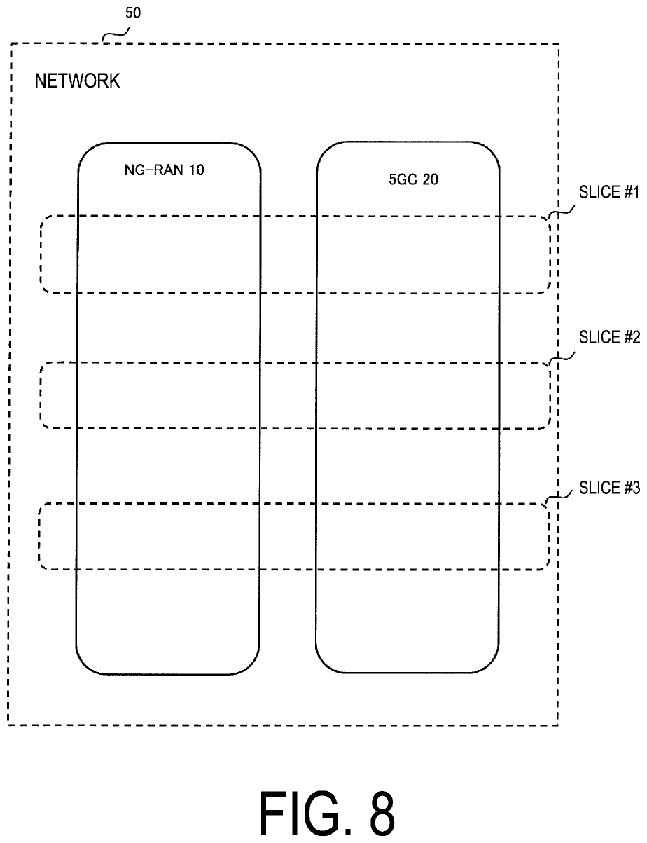

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (or slice)” may refer to an S-NSSAI that is an identifier of a single slice or an NSSA that is a collection of S-NSSAIs, or may refer to one or more S-NSSAIs or a slice group that is a group of NSSAIs.

The UE 100 also determines a desired network slice that the UE 100 wants to use. Such a desired slice may be referred to as an intended slice. In the first embodiment, the UE 100 determines a slice priority for each network slice (desired network slice). For example, the NAS of the UE 100 determines the slice priority based on an operation status of an application in the UE 100 and/or a user operation/setting, and notifies the AS of the determined slice priority.

### Overview of Slice-Specific Cell Reselection Procedure

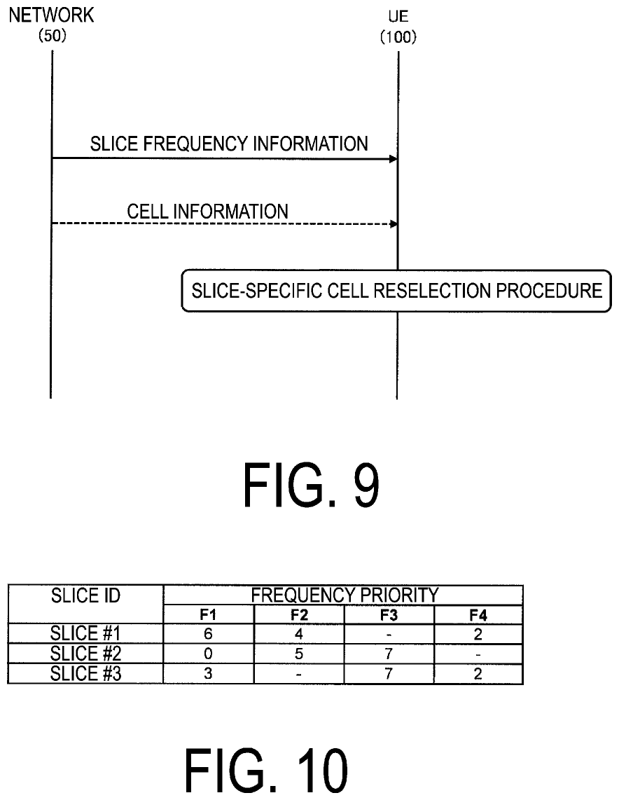

FIG. 9 is a diagram illustrating an overview of the slice-specific cell reselection procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

The UE 100 may perform the cell reselection processing further based on cell information provided from the network 50. The cell information may be information indicating a correspondence relationship between a cell (for example, a serving cell and each neighboring cell) and a network slice that is not provided or provided by the cell. For example, a cell may temporarily fail to provide some or all network slices due to congestion or the like. That is, even for a slice support frequency capable of providing a network slice, some cells within the frequency may not provide the network slice. Based on the cell information, the UE 100 may grasp which network slice is not provided by each cell. The cell information like this may be provided from the gNB 200 to the UE 100 through broadcast signaling (for example, a system information block) or dedicated signaling (for example, an RRC release message).

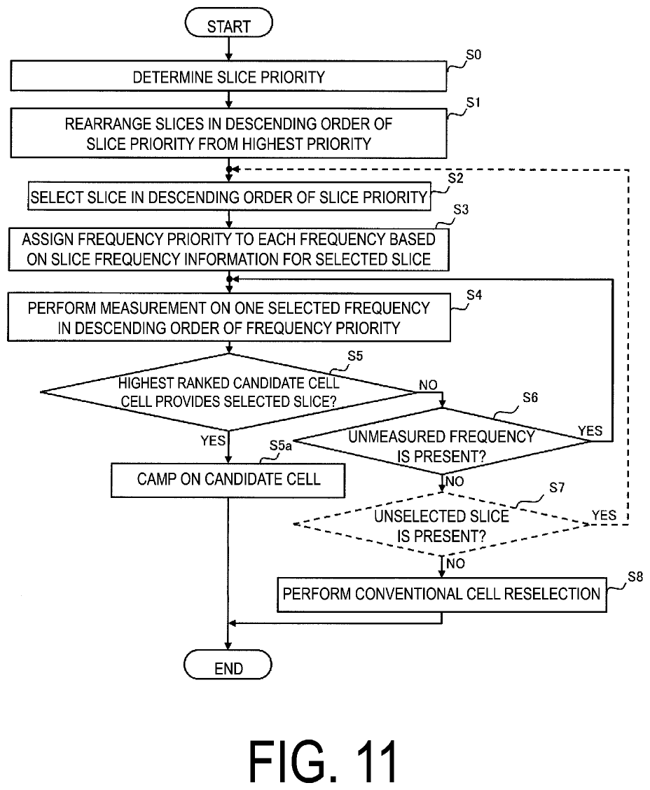

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information.

In step S0, the NAS of UE 100 determines the slice identifiers of the desired slices for the UE 100 and the slice priorities of the desired slices, and notifies the AS of the UE 100 of slice information including the determined slice priorities. The “desired slice” includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a cell ranked the highest based on the result of the measurement processing in step S4, and determines whether the cell provides the selected network slice based on the cell information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. In other words, the AS of the UE 100 determines whether a frequency to which the frequency priorities have been assigned in step S3 other than the selected frequency is present in the selected network slice. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. In other words, the AS of the UE 100 may determine whether a network slice other than the selected network slice is contained in the slice list. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of a general cell reselection procedure illustrated in FIG. 7, or may mean only cell reselection processing (step S30) illustrated in FIG. 7. In the latter case, the UE 100 may use the measurement result in step S4 without measuring the radio qualities of the cells again.

### Cell Reselection Method According to First Embodiment

As described above, the desired network slice is determined by the UE 100 itself. Therefore, the gNB 200 does not have desired network slice information related to the desired network slice.

On the other hand, the gNB 200 transmits the slice frequency information indicating a correspondence relationship between the network slices, the frequencies, and the frequency priorities to the UE 100.

The gNB 200, when having the desired network slice information, may be able to appropriately configure the frequency priorities. The UE 100 may be able to appropriately select the cell that provides the desired network slice through the slice-specific cell reselection procedure.

Therefore, in the first embodiment, an example is described in which the AMF 300 transmits the desired network slice information to the gNB 200.

To be specific, first, a control apparatus (for example, the AMF 300) acquires network slice information. Second, the control apparatus transmits the network slice information to the base stations (e.g., the gNB 200). Third, the base station determines the frequency priorities for the network slice by using the network slice information to transmit the determined frequency priorities for the network slice to the user equipment (for example, the UE 100). Fourth, the user equipment reselects a cell providing the network slice by using the frequency priorities for the network slice.

This allows the gNB 200, for example, to appropriately select the frequency priorities, based on the desired network slice information, so that the UE 100 can appropriately perform cell reselection.

### Operation Example According to First Embodiment

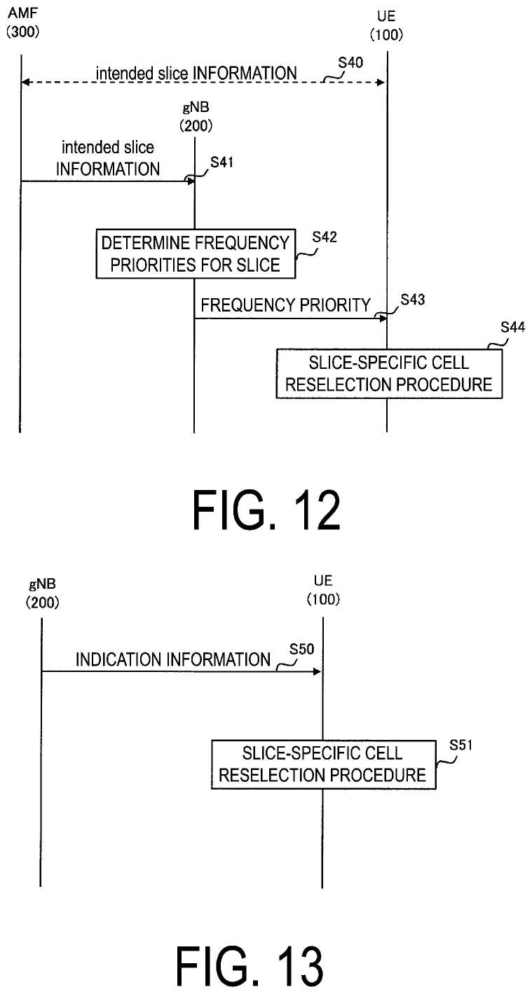

FIG. 12 is a diagram illustrating an operation example according to the first embodiment.

As illustrated in FIG. 12, in step S40, the AMF 300 acquires the desired network slice. The AMF 300 may communicate with the UE 100 and receive the desired network slice information from the UE 100 to acquire the information. The AMF 300 may determine and provide to the UE 100 the desired network slice for the UE 100 to acquire the information. The AMF 300 is an example of the control apparatus.

In step S41, the AMF 300 transmits the desired network slice information to the gNB 200.

The desired network slice information may be UE 100-specific desired network slice information. However, the gNB 200 does not have a context of the UE 100 when the UE 100 is in the RRC idle state. Therefore, the gNB 200 holds and uses the desired network slice information when the UE 100 is in the RRC inactive state or the RRC connected state.

The desired network slice information may be desired network slice information per tracking area (TA) or may be desired network slice information per RAN notification area (RNA). In this case, the desired network slice information may be information obtained by statistically processing the desired network slice information of a plurality of UEs 100. The desired network slice information may be a list of slices to which the same slice priority is assigned.

In step S42, the gNB 200 determines the frequency priorities for each network slice by using the desired network slice information. For example, the gNB 200 determines the frequency priorities for a first network slice represented as first desired network slice information of a UE #1 and a second network slice represented as second desired network slice information of a UE #2.

In other words, the gNB 200 determines the frequency priorities for each network slice by using the desired network slice information. At this time, the gNB 200 assigns the frequency priorities, all of which are different from each other for the network slices having the same slice priority. For example, in FIG. 10, assume that the slice priorities are the same for the slices #1 and #2, which are the desired network slices. In this case, the gNB 200 assigns the frequency priorities so that the frequency priorities assigned to the frequencies “F1”, “F2”, and “F4” for the slice #1 and the frequency priorities assigned to the frequencies “F1”, “F2”, and “F3” for the slice #2 are all different priorities. FIG. 10 illustrates an example in which the frequency priorities are assigned to the slices #1 and #2 as described above.

Note that the slice priority of each network slice is determined by the UE 100. Therefore, the slice priority may also be acquired by the AMF 300 (step S40) and transmitted to the gNB 200 (step S41) in a manner the same as and/or similar to the desired network slice information. Alternatively, the slice priority may be included in the desired network slice information.

In step S43 the gNB 200 provides the frequency priorities for each network slice to the UE 100.

In step S44, the UE 100 performs the slice-specific cell reselection procedure. In the procedure, in step S4 (FIG. 11), even for the selected network slices having the same priority, the frequency priorities are different from each other, so the network slice having the higher frequency priority can be selected.

### Second Embodiment

In the 3GPP, step S7 (“whether a frequency not selected is present”) of the slice-specific cell reselection procedure described above (FIG. 11) is a matter of future consideration. Therefore, at the present time, step S7 may or may not be applied.

When step S7 is applied and the cell reselection fails for the highest slice priority in the slice list, the cell reselection is attempted for the second slice priority that is the next highest priority in the slice list. The same applies to the third and subsequent slice priorities.

On the other hand, when step S7 is not applied, when the cell reselection fails for the highest slice priority, the conventional cell reselection (step S8) is made without shifting to the second slice priority. In other words, in this case, the highest slice priority is a target for the slice-specific cell reselection procedure and the other slice priorities are targets for the conventional cell reselection. When the cell reselection fails for the highest slice priority, a signal strength of the cell supporting the second slice priority may be possibly weak, and thus, it can be considered that connectivity of the UE 100 can be secured by making typical cell selection.

In practice, however, step S7 would be deployment dependent. In other words, depending on the operator or the area, the control may be optimized by applying or not applying step S7.

Therefore, in the second embodiment, an example is described in which the gNB 200 indicates to the UE 100 whether to apply step S7.

Specifically, first, receiving the slice frequency information indicating the correspondence relationship between the network slices, the frequencies, and the frequency priorities from the base station. Second, assigning the frequency priorities indicated by the slice frequency information to corresponding frequencies for a selected network slice selected by a user equipment from a slice list that includes network slices in order of slice priority. Third, determining whether a candidate cell provides the selected network slice, the candidate cell satisfying a predetermined quality standard within a selected frequency selected by the user equipment in accordance with the assigned frequency priorities. Fourth, determining whether another frequency to which the frequency priorities have been assigned other than the selected frequency is present in the selected network slice, when a cell providing the selected network slice is not present for the selected frequency. Fifth, determining or skipping the determining whether a network slice other than the selected network slice is present in the slice list in accordance with an indication from the base station, when another frequency to which the frequency priorities have been assigned other than the selected frequency is not present.

This allows the UE 100, for example, to perform step S7 or skip step S7 in accordance with the indication from the gNB 200, and thus, appropriately perform the cell reselection.

### Operation Example According to Second Embodiment

FIG. 13 is a diagram illustrating an operation example according to the second embodiment.

As illustrated in FIG. 13, in step S50, the gNB 200 transmits indication information of step S7 to the UE 100.

The indication information may indicate whether to perform the slice-specific cell reselection procedure (FIG. 11) for the slice having the second (or subsequent) slice priority that is the next highest priority below the highest slice priority in the slice list. Alternatively, the indication information may indicate that only the network slice having the highest slice priority is processed in the slice-specific cell reselection procedure. Alternatively, the indication information may be indication that the network slices having all slice priorities in the slice list are processed in the slice-specific cell reselection procedure. Alternatively, the indication information may be indication indicating a range of the slice priorities for performing the slice-specific cell reselection procedure. For example, the slice-specific cell reselection procedure may be performed to process the network slices having the third slice priority from the highest slice priority (the slice priority having the third highest priority in the slice list), and the typical cell reselection may be performed to process the network slices having the subsequent priorities (step S8).

Note that the indication information may be provided to the UE 100 through broadcast signaling (SIB), or may be provided to the UE 100 through an RRC release message.

In step S51, the UE 100 performs the slice-specific cell reselection procedure. At this time, the UE 100 can perform or skip step S7 in accordance with the indication information.

### Other Embodiments

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

1. A cell reselection method in a mobile communication system, the cell reselection method comprising:
acquiring, by a control apparatus, network slice information;
transmitting, by the control apparatus, the network slice information to a base station;
by the base station, determining frequency priorities for network slices by using the network slice information, and transmitting the determined frequency priorities for the network slices to a user equipment; and
reselecting, by the user equipment, a cell that provides the network slices, by using the frequency priorities for the network slice.

2. The cell reselection method according to claim 1, wherein
the network slices comprise a first network slice and a second network slice,
the transmitting the frequency priorities comprises determining, by the base station, a first frequency priority for the first network slice and a second frequency priority for the second network slice so that the first frequency priority is different from the second frequency priority, when a slice priority of the first network slice is the same as a slice priority of the second network slice.

3. A cell reselection method performed by a user equipment in a mobile communication system, the cell reselection method comprising:
receiving, from a base station, slice frequency information indicating a correspondence relationship between network slices, frequencies, and frequency priorities;
assigning the frequency priorities indicated by the slice frequency information to corresponding frequencies for a selected network slice selected by a user equipment from a slice list that comprises network slices in order of slice priority;
determining whether a candidate cell provides the selected network slice, the candidate cell satisfying a predetermined quality standard within a selected frequency selected by the user equipment in accordance with the assigned frequency priorities;
determining whether another one of the corresponding frequencies to which the frequency priorities have been assigned other than the selected frequency is present for the selected network slice, when a cell providing the selected network slice in the selected frequency is not present; and
determining or skipping the determining whether a network slice other than the selected network slice is present in the slice list in accordance with an indication from the base station, when another one of the corresponding frequencies to which the frequency priorities have been assigned other than the selected frequency is not present.

4. The cell reselection method according to claim 3, wherein
the selected network slice is a network slice having a first priority that is the highest slice priority in the slice list, and
the indication indicates whether to perform a slice-specific cell reselection procedure for a network slice having a second priority that is the next highest slice priority below the first priority in the slice list.

5. A user equipment, comprising:
a circuitry configured to perform:
processing of receiving, from a base station, slice frequency information indicating a correspondence relationship between network slices, frequencies, and frequency priorities
processing of assigning the frequency priorities indicated by the slice frequency information to corresponding frequencies for a selected network slice selected by a user equipment from a slice list that comprises network slices in order of slice priority;
processing of determining whether a candidate cell provides the selected network slice, the candidate cell satisfying a predetermined quality standard within a selected frequency selected by the user equipment in accordance with the assigned frequency priorities;
processing of determining whether another one of the corresponding frequencies to which the frequency priorities have been assigned other than the selected frequency is present for the selected network slice, when a cell providing the selected network slice in the selected frequency is not present; and
processing of determining or skipping the determining whether a network slice other than the selected network slice is present in the slice list in accordance with an indication from the base station, when another one of the corresponding frequencies to which the frequency priorities have been assigned other than the selected frequency is not present.
